(19) United States
(12) Patent Application Publication
(10) Pub. No.: US 2014/0065432 A1
(43) Pub. Date: Mar. 6, 2014

(54) Adhesive Compositions With Reduced Levels of Volatile Organic Compounds

(71) Applicant: 3M INNOVATIVE PROPERTIES COMPANY, St. Paul, MN (US)

(72) Inventors: Daniel W. Wuerch, Maplewood, MN (US); John E. Gozum, Stillwater, MN (US)

(73) Assignee: 3M INNOVATIVE PROPERTIES COMPANY, St. Paul, MN (US)

(21) Appl. No.: 14/014,449

(22) Filed: Aug. 30, 2013

Related U.S. Application Data
(60) Provisional application No. 61/694,843, filed on Aug. 30, 2012.

(51) Int. Cl. C09J 11/06

(52) U.S. Cl. CPC C09J 11/06
USPC 428/447; 524/269; 156/329

(57) ABSTRACT

There are provided non-aqueous adhesive compositions comprising a) a styrene-containing polymer, b) modifying agent, and c) a solvent system comprising i) a volatile siloxane compound, and ii) a second compound selected from acetone, methyl acetate, tert-butyl acetate, para-chlorobenzotrifluoride, and combinations thereof. Bonded articles and methods of bonding articles using these compositions are also provided.

### TECHNICAL FIELD

The present disclosure relates to adhesive compositions containing reduced levels of volatile organic compounds and articles made therefrom. The present disclosure also relates to sprayable adhesive compositions.

### BACKGROUND

Adhesive compositions are often provided as solutions in one or more organic solvents. The solvent(s) are necessary to dissolve the adhesive so that it may be easily applied to various substrates during bonding operations. After application the solvent is allowed to at least partially evaporate before the substrates are joined together.

For environmental, health, and safety reasons, many of the most commonly used organic solvents are deemed undesirable. Various state and federal government agencies have passed regulations restricting the use of such materials. For example, in California there are both local air district regulations as well as state regulations addressing this matter. On the federal level the Environmental Protection Agency (EPA) deals with the subject of volatile organic compounds (VOCs). According to the EPA definition found in 40 CFR (Code of Federal Regulations) 51.100(s) as of the date of filing, a volatile organic compound means any compound of carbon, excluding carbon monoxide, carbon dioxide, carbonic acid, metallic carbides or carbonates, and ammonium carbonate, which participates in atmospheric photochemical reactions. Generally speaking, an organic compound is classified as a VOC unless it is proven to have negligible photochemical reactivity. Some examples of solvents that the EPA exempts from VOC status based on their negligible photochemical reactivity include acetone, methyl acetate, tert-butyl acetate, methylene chloride, volatile methyl siloxanes, perchloroethylene, and parachlorobenzotrifluoride (PCBTF). Additional solvents that the EPA exempts from being classified as VOC's can be found in 40 CFR 51.100(s). The EPA and various state regulatory bodies continue to mandate reductions in the amount of VOC's that may be used in adhesives. Because of these ongoing VOC reduction efforts, industry in general has a strong need to find good, effective solvent systems with negligible photochemical reactivity that can meet the increasingly restrictive VOC requirements.

Unfortunately, many organic solvents that exhibit low photochemical reactivity are subject to other limitations or regulations. For example, some solvents are classified as “ozone depleters” under the Montreal Protocol whereas others are regulated by the EPA as “hazardous air pollutants” (HAP solvents). As a result there are relatively few organic solvents which have low photochemical reactivity and are useful for dissolving adhesives, yet are not classified as either ozone depleters or HAP solvents.

Various approaches have been taken by industry to reduce the VOC content of liquid adhesives. These include developing and evaluating new polymers, utilizing more VOC-exempt solvents, developing higher solids content formulations, and employing water-based systems. While some progress has been made, many limitations still exist. For example, water-based systems may contain low or almost zero VOC content, but water dries more slowly and prevents such systems from being useful in many industrial applications. Also, many of the solvent-based adhesives still contain greater than 25 wt % of VOC content which is a relatively significant amount of VOC that is emitted to the air. The adhesive industry still needs non-aqueous solvent systems that are low in toxicity, not regulated as HAP solvents or ozone depleters, have good solubility for adhesive compositions, and have negligible photochemical reactivity which can be used to produce useful adhesive compositions that have reduced VOC content.

### SUMMARY

There is a need for non-aqueous adhesive compositions having reduced amounts of volatile organic compounds. In one aspect a non-aqueous adhesive composition is provided comprising a) a styrene-containing polymer, b) modifying agent, and c) a solvent system comprising i) a volatile siloxane compound and ii) a second compound selected from acetone, methyl acetate, tert-butyl acetate, para-chlorobenzotrifluoride, and combinations thereof.

### DETAILED DESCRIPTION

As used herein, the terms

“a”, “an”, “the”, and “at least one of” are used interchangeably and mean one or more; “and/or” is used to indicate one or both stated cases may occur, for example A and/or B includes, (A and B) and (A or B);

“interpolymerized” refers to monomers which are polymerized together to form a polymer backbone;

“room temperature” refers to a temperature in the range of 20° C. to 25° C.;

“copolymer” refers to a polymeric material comprising at least two different “polymer”

“polymer: refers to a polymeric material comprising interpolymerized units of the same monomer (a homopolymer) or of different monomers (a copolymer); and

Also herein, recitation of ranges by end points includes the end points and all numbers subsumed within that range (e.g., 1 to 10 includes 1.4, 1.9, 2.33, 5.75, 9.98, etc.).

The present disclosure relates to non-aqueous adhesive compositions having a reduced amount of volatile organic compounds (VOCs). By “a reduced amount” it is meant the non-aqueous adhesive compositions contain 25 wt % or less of such compounds. A definition of VOCs as given by the EPA can be found in 40 CFR 51.100(s), and may be summarized as any compound of carbon, excluding carbon monoxide, carbon dioxide, carbonic acid, metallic carbides or carbonates, and ammonium carbonate, which participates in atmospheric photochemical reactions. Generally speaking, an organic compound is classified as a VOC unless it has been proven to have negligible photochemical reactivity.

In one aspect the non-aqueous adhesive compositions of the present disclosure comprise a styrene-containing polymer, a modifying agent, and a solvent system comprising a volatile siloxane compound and a second compound selected from acetone, methyl acetate, tert-butyl acetate, and para-chlorobenzotrifluoride.

Non-aqueous adhesive compositions of the present disclosure may be applied to one or more substrates to be bonded by a variety of means well known to those skilled in art including brushing, rolling, spraying, pumping, dipping, etc. After application the solvent is allowed to at least partially evaporate before joining the substrates together.

Surprisingly it has been found that volatile siloxane compounds may be used to provide non-aqueous adhesive compositions having 25 wt % or less of VOCs. In other aspects the compositions have 20 wt % or less, 15 wt % or less, 10 wt % or less, or even 5 wt % or less of VOCs. In addition, such adhesive compositions may also be provided as sprayable adhesives.

### Styrene-Containing Polymer

The non-aqueous adhesive compositions of the present disclosure include a styrene-containing copolymer. This copolymer may be comprised of a random styrene-butadiene rubber (SBR) or a block copolymer comprising at least one styrene block. The block copolymer may be, for example, a diblock, triblock, multi-block, radial, or star block copolymer. Examples of suitable styrene block copolymers include, but are not limited to, styrene-butadiene-styrene (SBS) (commercially available as KRATON D1102 and KRATON D1118 from KRATON Performance Polymers, Incorporated, Houston, Tex.), styrene-isoprene-styrene (SIS) (commercially available as VECTOR 4411A from Dexco Polymers, LP, Houston, Tex.), styrene-ethylene-butylene-styrene (SEBS) (commercially available as KRATON G1652 from KRATON Performance Polymers), styrene-ethylene-butylene (SEB), styrene-ethylene-propylene-styrene (SEPS) (commercially available as SEPTON 2002 from Kuraray Company, Ltd., Houston, Tex.), styrene-ethylene-propylene (SEP) (commercially available as SEPTON 1001 from Kuraray Company), styrene-ethylene-(ethylene/propylene)-styrene (SEEPS) (commercially available as SEPTON 4033 from Kuraray Company), styrene-isobutylene-styrene (commercially available as SIBSTAR 103T from Texas Corporation, Houston, Tex.), and styrene-isoprene-butadiene-styrene.

### Modifying Agent

The non-aqueous adhesive compositions of the present disclosure also include a modifying agent. For example, various modifying agents such as tackifying resins (“tackifiers”) and plasticizing agents (“plasticizers”) may be added to the composition to adjust the glass transition temperature or modulus of the composition in order to improve its adhesive properties and tack. Other modifying agents may be employed to increase heat resistance or hardness of the adhesive composition.

Examples of suitable tackifiers include rosins and their derivatives (e.g. rosin esters), (commercially available as SYLVALITE RE100L from Arizona Chemical, Jacksonville, Fla.; and PERMALYN 2085 and PERMALYN 5110 from Eastman Chemical Company, Kingsport, Tenn.);

polyterpenes such as for example, alpha pinene-based resins, beta pinene-based resins, and limonene-based resins (commercially available as, for example, SYLVARES TR 7115 from Arizona Chemical) and aromatic-modified polyterpene resins; hydrocarbon resins, for example, aliphatic hydrocarbon-based resins (commercially available as QUINTONE K100 from Zeon Corporation, Tokyo, Japan, and WINGTACK 95 from Cray Valley USA, LLC, Exton, Pa.) and aromatic-modified hydrocarbon-based resins (commercially available as ESCOREZ 2203LC from ExxonMobil Chemical Company, Houston, Tex.); and combinations thereof. Non-hydrogenated tackifier resins are typically less durable (i.e. weatherable). Hydrogenated (either partially or completely) tackifiers may also be used. Examples of hydrogenated tackifiers include, for example, hydrogenated rosin esters (commercially available as FORAL 85 from Pinova, Incorporated, Brunswick, Ga.); hydrogenated acids; hydrogenated aromatic hydrocarbon resins; hydrogenated aromatic-modified hydrocarbon-based resins; hydrogenated aliphatic hydrocarbon-based resins; and combinations thereof. Synthetic tackifiers including phenolic resins (commercially available as SP-154 from SI Group, Incorporated, Schenectady, N.Y.); terpene phenolic resins (commercially available as SYLVARES TP96 from Arizona Chemical); poly-t-butyl styrene; and combinations thereof may also be employed.

Examples of suitable plasticizers include hydrocarbon oils (e.g. those that are aromatic, paraffinic, or naphthenic); hydrocarbon resins; rosin esters; phthalates (e.g., terephthalate), phosphate esters; dibasic acid esters (e.g. the dioctyl esters of the following polycarboxylic acids: sebacic acid, adipic acid, citric acid, trimellitic acid, dibenzoic acid); fatty acid esters; polyethers (e.g., alkyl phenyl ether); epoxy resins; and combinations thereof.

Examples of other modifying agents include, for example, coumarone-indene resins (commercially available as CUMAR R-12, Neville Chemical Company, Pittsburgh, Pa.) and aromatic hydrocarbon resins (commercially available as NEVCHEM 140 from Neville Chemical Company, Pittsburgh, Pa., and ENDEX 160 from Eastman Chemical Company, Kingsport, Tenn.).

In one aspect the modifying agent comprises at least one tackifier. In another aspect the modifying agent comprises at least one plasticizer in combination with at least one tackifier.

### Solvent System

The non-aqueous adhesive compositions of the present disclosure include a solvent system comprising at least one volatile siloxane compound in combination with a second compound selected from acetone, methyl acetate, tert-butyl acetate, para-chlorobenzotrifluoride, and combinations thereof.

### Volatile Siloxane Compound

It has been unexpectedly found that volatile methylated siloxane compounds may be used in place of VOCs, such as pentane, cyclohexane, and toluene, to provide non-aqueous adhesive compositions which are free of agglomeration and precipitation. This finding is surprising in view of the inability of other VOC exempt materials, such as 1,1-difluoroethane and methoxy-nonafluorobutane, to provide similar results based on solubility studies. As a result, in one aspect, a solvent system comprising as few as two compounds, both of which are VOC exempt, may be employed to provide non-aqueous adhesive compositions having 25 wt % or less of VOCs. In other aspects the compositions have 20 wt % or less, 15 wt % or less, 10 wt % or less, or even 5 wt % or less of VOCs. Such adhesive compositions are able to meet many of the federal, state, and local regulations described above thereby addressing an ongoing industry need.

Volatile silicone solvents that are currently considered VOC exempt by the EPA include linear, cyclic, and branched siloxanes that are completely methylated. In one aspect the siloxane compound contains 2 to 7 silicon atoms. In another aspect the siloxane compound contains silicon atoms that are bonded to alkyl and/or alkoxy groups containing 1 to 10 carbon atoms. Examples of such materials include low-viscosity silicone compounds such as octamethylcylcotetrasiloxane (available from Sigma-Aldrich Corporation, Saint Louis, Mo.); decamethylcyclopentasiloxane (available from Sigma-Aldrich Corporation, and as DOW CORNING 245 FLUID from Dow Corning Corporation, Midland Mich.); dodecamethylcyclohexasiloxane (available from Sigma-Aldrich Corporation); octamethyltrisiloxane (available as DOW CORNING 200 FLUID, 1 cSt from Dow Corning); decamethyltetrasiloxane (available as DOW CORNING 200 FLUID, 1.5 cSt from Dow Corning); hexamethyldisiloxane (available as DOW CORNING, 200 FLUID 0.65 cSt from Dow Corning, SILICONE FLUID AK 0.65 from Wacker Chemical Corporation, Adrian, Mich., and ANDISIL SF 0.65 from Anderson & Associates, Waukegan, Ill.); and mixtures thereof. By the term “low viscosity” it is meant the viscosity is 50 centiStokes (mm²/sec) or less, 30 centiStokes (mm²/sec) or less, or even 15 centiStokes (mm²/sec) or less.

### Second Compound

The second compound of the solvent system is selected from acetone, methyl acetate, tert-butyl acetate, para-chlorobenzotrifluoride, and combinations thereof. These solvents (also referred to herein as “non-VOC solvent”) are currently listed as exempt from the EPA list of VOCs. In some aspects the second solvent is selected from acetone, methyl acetate, and the combination thereof. These provide some advantages over tert-butyl acetate and para-chlorobenzotrifluoride including faster drying times and less odor. In addition, tert-butyl acetate is not universally considered VOC exempt. For example some state localities do not recognize it as so.

It is understood that trace amounts of VOCs may be present in the materials used to prepare the non-aqueous adhesive compositions of the present disclosure. In such instances the compositions are considered herein to be substantially free of VOCs, that is, they are expected to contain less than 5 wt % of VOCs.

The compositions of the present disclosure may also include one or more VOC solvents. Examples of such solvents include, but are not limited to, alkanes containing five to sixteen carbon atoms (herein referred to as C5 to C16 alkanes) such as n-pentane, hexane, isohexane, cyclohexane, cyclopentane, isododecane, isodecane; esters such as n-butyl acetate, ethyl acetate, propyl acetate; ketones such as methyl ethyl ketone, methyl isobutyl ketone, diisobutyl ketone, isophorone, cyclohexanone; ethers such as dimethoxymethane, diethoxyethane or diethyl ether; glycol ethers such as s-butoxyethanol, butyl diglycol, diethylene glycol momonethyl ether, propylene glycol n-butyl ether; aromatic hydrocarbons such as toluene and xylene; chlorinated solvents such as trans 1,2-dichloroethylene; or any mixtures thereof.

The combination of volatile siloxanes with acetone, methyl acetate, tert-butyl acetate, para-chlorobenzotrifluoride, and combinations thereof provides a solvent system that is surprisingly effective at providing easily handled styrene-containing liquid adhesive compositions that are free of agglomeration and precipitation. By virtue of being free of agglomeration and precipitation the non-aqueous adhesive compositions of the present disclosure are suitable for application by brushing, rolling, spraying, pumping, dipping, etc. In one aspect the non-aqueous adhesive compositions of the present disclosure comprises 100 parts by weight of styrene-containing polymer, 25 to 200 parts by weight of tackifier per 100 parts styrene-containing polymer, 0 to 200 parts by weight plasticizer per 100 parts styrene-containing polymer, 0 to 100 of other modifying agents per 100 parts styrene-containing polymer, 20 to 400 parts by weight of a volatile siloxane compound per 100 parts styrene-containing polymer, 30 to 800 parts by weight of a non-VOC solvent per 100 parts styrene-containing polymer, and 0 to 200 parts by weight of VOC solvent (including propellant(s)) per 100 parts styrene-containing polymer. In some aspects the tackifier may be present in an amount of 30 parts by weight to 200 parts by weight, 40 parts by weight to about 200 parts by weight, 50 parts by weight to about 150 parts by weight, or even 60 parts by weight to about 125 parts by weight, per 100 parts by weight of the styrene-containing copolymer.

In other aspects a plasticizer may be present in the composition in amounts up to 50 parts by weight, 70 parts by weight, 100 parts by weight, or even 200 parts by weight based on 100 parts by weight of the styrene-containing copolymer.

In additional aspects the volatile siloxane compound may be present in the composition in an amount of from 50 to 300 parts by weight, 75 to 200 parts by weight, or even 100 to 150 parts by weight based on 100 parts by weight of the styrene-containing copolymer.

In further aspects the non-VOC solvent may be present in the composition in an amount of from 100 to 600 parts by weight, 150 to 500 parts by weight, or even 250 to 350 parts by weight based on 100 parts by weight of the styrene-containing copolymer.

In some aspects the VOC solvent (including propellant(s)) may be present in the composition in an amount of from 25 to 190 parts by weight, 50 to 180 part by weight, or even 100 to 175 parts by weight based on 100 parts by weight of the styrene-containing copolymer.

The non-aqueous adhesive compositions of the present disclosure may be provided as having a solids content of from 10 to 70 wt %, 15 to 50 wt %, or even 20 to 40 wt %.

Such compositions contain 3 to 40 wt % of styrene-containing polymer, 3 to 40 wt % of tackifier, 0 to 50 wt % of plasticizer, 5 to 50 wt % of a volatile siloxane compound, 10 to 90 wt % of a non-VOC solvent, and 0 to 25 wt % of VOC solvent (including propellant(s)).

In some aspects the styrene-containing polymer may be present in an amount of 5 to 35 wt %, 10 to 30 wt %, or even 15 to 25 wt % of the non-aqueous adhesive compositions.

In other aspects the tackifier may be present in an amount of 5 to 35 wt %, 10 to 30 wt %, or even 15 to 25 wt % of the non-aqueous adhesive compositions.

In further aspects the volatile siloxane compound may be present in an amount of 7 to 40 wt %, 10 to 30 wt %, or even 12 to 20 wt % of the non-aqueous adhesive compositions.

In additional aspects the non-VOC solvent may be present in an amount of 20 to 75 wt %, 25 to 50 wt %, or even 30 to 40 wt % of the non-aqueous adhesive compositions.

In some aspects the VOC solvent (including propellant(s)) may be present in an amount of 5 to 23 wt %, 10 to 21 wt %, or even 15 to 20 wt % of the non-aqueous adhesive compositions.

In one aspect the non-aqueous adhesive compositions of the present disclosure may be applied by spraying. Spraying of an adhesive presents specific challenges and, therefore, not all adhesive compositions may be used for spraying. For example, the adhesive should not only provide adequate adhesion once dispensed, but should flow out of the containment vessel in a usable spray, should not gum up the delivery mechanism (such as the valve or actuator), and should not cause excessive soak-in of the substrate to which it was applied.

Sprayable adhesive compositions may include a polymer, along with any modifying component; a solvent, which acts to dilute, or suspend the adhesive; a propellant; and any other desired additives. The propellant may include a liquefied gas, a compressed gas, or combinations thereof. Liquefied gas propellants and compressed gas propellants are well known to those skilled in the art. Exemplary liquefied gas propellants include C1-C4 alkanes (such as propane, butane, isobutane, cyclobutane, or combinations thereof), hydrochlorofluorocarbons, hydrofluorocarbons (such as trans-1,3,3,3-tetrafluoroprop-1-ene available from Honeywell International, Incorporated, Morristown, N.J.), 1,1-difluoroethane and tetrafluoroethane (available from E.I. du Pont de Nemours and Company, Wilmington, Del.), dimethyl ether, and combinations thereof. Exemplary compressed gas propellants include carbon dioxide, nitrogen, nitrous oxide, compressed air, and combinations thereof.

In one aspect sprayable non-aqueous adhesive compositions may be provided in a self-contained form. That is, the non-aqueous adhesive composition with propellant is provided in a single container (eg., cylinder (often referred to as an aerosol canister) or aerosol can) from which it may be directly sprayed. The propellant present with adhesive composition is the sole source of pressure used to drive and spray the adhesive composition from the container.

In another aspect sprayable non-aqueous adhesive compositions without propellant may be provided in a bulk container (eg., can, pail, drum, tote-tank) and employ an external source of pressure to spray or atomize the adhesive composition from the container. The external source of energy may be liquefied or compressed gases, as described above, from a second container. In a further aspect, sprayable non-aqueous adhesive compositions having some propellant content may be provided in a bulk container and employ an external source of pressure as described above. In this aspect the amount of propellant is insufficient to act alone to provide suitable sprayability, and the external pressure source acts as the primary source of pressure to ensure acceptable spraying characteristics.

Aerosol delivery devices are known to those skilled in the art. Such devices include a containment vessel comprising a valve and/or an actuator. Exemplary valves and/or actuators can be obtained from SeaquistPerfect Dispensing, Cary, Ill.; Lindal Valve Company, Ltd., Bedfordshire England; Newman-Green Incorporated, Addison, Ill.; Precision Valve Corporation, Yonkers, N.Y.; and Summit Packaging Systems, Incorporated, Manchester, N.H. Canister based systems such as e.g., cylinders, typically have a hose attached between the valve and the actuator (e.g., spray gun). An exemplary valve manufacturer for cylinders is Grand Gas Equipment Incorporated, Taichung, Taiwan.

In one aspect of the present disclosure, the solids content of the sprayable adhesive composition is at least 10 wt %, at least 15 wt %, at least 20 wt %, or even at least 25 wt %, of the total weight.

In another aspect of the present disclosure, the solids content of the sprayable adhesive composition is 50 wt % or less, 40 wt % or less, or even 35 wt % or less of the total weight.

In some aspects, it is desirable to deliver as much adhesive as possible in a spray. Typically however, the amount of adhesive delivered is reduced due to the amount of solvent and propellant that are needed to disperse or solubilize the adhesive to facilitate spraying.

In some aspects the non-aqueous adhesive compositions of the present disclosure may include one or more additives including, for example, stabilizers (e.g., antioxidants or UV-stabilizers), corrosion inhibitors, pigments, dyes, thickeners, or combinations thereof. Such additives may each be present in an amount from about 0.01% to 5% by weight based upon the total weight of the non-aqueous adhesive composition.

Examples of antioxidants that may be employed include, but are not limited to phenols, phosphites, thioesters, amines, polymeric hindered phenols, copolymers of 4-ethyl phenols, and combinations thereof. An example of commercially available antioxidants are the phenolic-based antioxidants sold under the trade designation CIBA IRGANOX 1010 from Ciba Specialty Chemicals Corporation, Tarrytown, N.Y.

Examples of UV-absorbers include, but are not limited to: benzotriazole compounds such as 5-trifluoromethyl-2-(−2-hydroxy-3-alpha-cumyl-5-tert-octylphenyl)-2H-benzotriazole, 2-(2-hydroxy-3,5-di-alpha-cumylphehyl)-2H-benzotriazole, 5-chloro-2-(2-hydroxy-3-tert-butyl-5-methylphenyl)-2H-benzothiazole, 5-chloro-2-(2-hydroxy3,5-di-tert-butylphenyl)-2H-benzotriazole, 2-(2-hydroxy-3,5-di-tert-amylphenyl)-2H-benzotriazole, 2-(2-hydroxy-3-alpha-cumyl-5-tert-octylphenyl)-2H-benzotriazole, 2-(3-tert-butyl-2-hydroxy-5-methylphenyl)-5-chloro-2H-benzotriazole, as well as phenols such as 2(-4,6-diphenyl-1-3,5-triazin-2-yl)-5-hexcyloxy-phenol, and combinations thereof. Examples of commercially available UV absorbers include those available from Ciba Specialty Chemicals Corporation sold under the trade designations CIBA TINUVIN 1577 and CIBA TINUVIN 900.

In addition, one or more UV-absorbers may be used in combination with one or more hindered amine light stabilizers (HALS) and/or anti-oxidants. Examples of commercially available HALSs include those available from Ciba Specialty Chemicals Corporation sold under the trade designations CIBA CHIMASSORB 944 and CIBA TINUVIN 123.

Examples of corrosion inhibitors include, but are not limited to, sulphonates, morpholine, benzotriazole, ammonium nitrite, acetylenic derivatives, sodium molybdate, formamide, various amines, sodium benzoate, sodium nitrite, quaternary ammonium nitrites, sodium silicate, sodium tetraborate, and combinations thereof. Other corrosion inhibitors that may be used include those disclosed in “Corrosion Inhibitors, An Industrial Guide” (Ernest W. Flick, 2nd edition, Noyes Publications, Park Ridge, N.J., 1993).

The non-aqueous adhesive compositions disclosed herein are useful for bonding one or more types of substrates to each other. In one aspect this may be done by applying the non-aqueous adhesive composition to at least one substrate, letting it at least partially dry, and then joining it to a second substrate. In another aspect, the non-aqueous adhesive composition is applied to two or more substrates which are subsequently joined to each other and/or other substrates that are free of the adhesive composition. Examples of suitable substrates include, but are not limited to, wood, laminates, paper, glass, carbon filter, concrete, ceramics, metals, steel, cloth, composites, plastics, vinyl, rubbers, cardboard, particle boards, plywood, fiberboard, or combinations thereof. Advantages and aspects of this invention are further illustrated by the following examples, but the particular materials and amounts thereof recited in these examples, as well as other conditions and details, should not be construed to unduly limit this disclosure.

Materials

| | |
|---|---|
| V4411 | A styrene-isoprene-styrene triblock copolymer |
| | having an approximate styrene content of 44% |
| | and less than 1% diblock content, available as |
| | VECTOR 4411A from DEXCO Polymers, |
| | Houston, TX. |
| K1118 | A clear, diblock copolymer based on styrene |
| | and butadiene, with a bound styrene of 33% |
| | mass and a diblock content of 78%, available |
| | from Kraton Polymers, LLC, Houston, TX. |
| HMDS | Hexamethyldisiloxane, available as SILICONE |
| | FLUID AK 0.65 from Wacker Chemical |
| | Corporation, Adrian, MI. |
| HFE 7100 | Methoxy-nonafluorobutane, available as 3M ™ |
| | NOVEC ™ 7100 Engineered Fluid from 3M |
| | Company, Saint Paul, MN. |
| D152a | 1,1-difluoroethane, a propellant, available from |
| | E. I. du Pont de Nemours and Company, |
| | Wilmington, DE, that was used primarily as a |
| | solvent in the examples. |
| PCBTF | Para-chlorobenzotrifluoride, available from |
| | Special Materials Company, New York, NY. |
| TBAC | t-Butyl acetate, available from Lyondell |
| | Chemical Company, Houston, TX. |
| Mac | Methyl acetate, available from Eastman |
| | Chemical Company, Kingsport, TN. |
| CHex | Cyclohexane, available from Sigma-Aldrich |
| | Company, Saint Louis, MO. |

### Examples 1-4 and Comparative Examples 1-6

The solubility of V4411 in a co-solvent system containing methyl acetate as the main solvent and a secondary non-VOC solvent was evaluated by adjusting the amount of the secondary non-VOC solvent. For each example the materials were added to glass jars and then placed on a roller overnight before inspecting for agglomeration or precipitation. For those examples where D152a was employed all other materials were first added to a glass aerosol bottle then a valve was crimped on to seal the bottle. Finally D152a was added to the bottle. The amounts and results are shown in Table 1 below

### Examples 5 and 6 and Comparative Examples 7-13

A second set of solubility experiments was carried out in a manner similar to those shown in Table 1 with the following modification. K1118 was used in place of V4411. The amounts and results are shown in Table 2 below.

TABLE 1

| | CE 1 | Ex. 1 | Ex. 2 | CE 2 | CE 3 | CE 4 | CE 5 | CE 6 | Ex. 3 | Ex 4 |
|---|---|---|---|---|---|---|---|---|---|---|
| | Wt | Wt | Wt | Wt | Wt | Wt | Wt | Wt | Wt | Wt |
| | (gm) | (gm) | (gm) | (gm) | (gm) | (gm) | (gm) | (gm) | (gm) | (gm) |
| V4411 | 2 | 2 | 2 | 2 | 2 | 2 | 2 | 2 | 2 | 2 |
| MAc | 50 | 40 | 35 | 45 | 40 | 35 | 40 | 35 | 40 | 40 |
| CHex | 1 | 1 | 1 | 1 | 1 | 1 | 1 | 1 | 1 | 1 |
| HMDS | 0 | 10 | 15 | 0 | 0 | 0 | 0 | 0 | 0 | 0 |
| D152a | 0 | 0 | 0 | 5 | 10 | 15 | 0 | 0 | 0 | 0 |
| HFE 7100 | 0 | 0 | 0 | 0 | 0 | 0 | 10 | 15 | 0 | 0 |
| PCBTF | 0 | 0 | 0 | 0 | 0 | 0 | 0 | 0 | 10 | 0 |
| TBAC | 0 | 0 | 0 | 0 | 0 | 0 | 0 | 0 | 0 | 10 |
| Total | 53 | 53 | 53 | 53 | 53 | 53 | 53 | 53 | 53 | 53 |
| Result | cloudy | cloudy | clear | rubber | rubber | rubber | rubber | rubber | slightly | slightly |
| | with | solution | solution | not | not | not | not | not | cloudy | cloudy |
| | rubber | | | dissolved | dissolved | dissolved | dissolved | dissolved | solution | solution |
| | not | | | | | | | | | |
| | dissolved | | | | | | | | | |

TABLE 2

| | CE 7 | CE 8 | CE 9 | Ex 5 | Ex 6 | CE 10 | CE 11 | CE 12 | CE 13 |
|---|---|---|---|---|---|---|---|---|---|
| | Wt | Wt | Wt | Wt | Wt | Wt | Wt | Wt | Wt |
| | (gm) | (gm) | (gm) | (gm) | (gm) | (gm) | (gm) | (gm) | (gm) |
| K1118 | 2 | 2 | 2 | 2 | 2 | 2 | 2 | 2 | 2 |
| MAc | 40 | 30 | 20 | 40 | 30 | 20 | 40 | 30 | 20 |
| CHex | 10 | 10 | 10 | 10 | 10 | 10 | 10 | 10 | 10 |
| HMDS | 0 | 0 | 0 | 10 | 20 | 30 | 0 | 0 | 0 |
| 152a | 0 | 0 | 0 | 0 | 0 | 0 | 10 | 20 | 30 |
| HFE7100 | 10 | 20 | 30 | 0 | 0 | 0 | 0 | 0 | 0 |
| Total | 62 | 62 | 62 | 62 | 62 | 62 | 62 | 62 | 62 |
| Result | rubber | rubber | rubber | clear | clear | soft | rubber | rubber | rubber |
| | not | not | not | solution | solution | rubber | not | not | not |
| | dissolved | dissolved | dissolved | | | mass | dissolved | dissolved | dissolved |

1. A non-aqueous composition comprising:
a. a styrene-containing polymer,
b. modifying agent, and
c. a solvent system comprising:
i. a volatile siloxane compound, and
ii. a second compound selected from acetone, methyl acetate, tert-butyl acetate, para-chlorobenzotrifluoride, and combinations thereof;
wherein the non-aqueous composition is an adhesive.

2. The non-aqueous composition of claim 1 wherein the second compound is selected from acetone, methyl acetate, and a combination thereof.

3. The non-aqueous composition of claim 1 wherein the amount of volatile siloxane compound is 25 wt % or less.

4. The non-aqueous composition of claim 3 wherein the amount of volatile siloxane compound is 15 wt % or less.

5. The non-aqueous composition of claim 4 wherein the amount of volatile siloxane compound is 5 wt % or less.

6. The non-aqueous composition of claim 1 wherein the volatile siloxane compound is a completely methylated linear, branched, or cyclic siloxane.

7. The non-aqueous composition of claim 6 wherein the volatile siloxane compound contains 2 to 7 silicon atoms bonded to alkyl and/or alkoxy groups containing 1 to 10 carbon atoms.

8. The non-aqueous composition of claim 1 wherein the non-aqueous composition is sprayable.

9. The sprayable non-aqueous composition of claim 8 further comprising a propellant.

10. The sprayable non-aqueous composition of claim 9 wherein the propellant is a compressed gas, a liquefied gas, or combination thereof.

11. A bonded article comprising:
a. at least two substrates, and
b. a non-aqueous composition comprising:
i. a styrene-containing polymer,
ii. modifying agent, and
iii. a solvent system comprising:
1. a volatile siloxane compound, and
2. a second compound selected from acetone, methyl acetate, tert-butyl acetate, para-chlorobenzotrifluoride, and combinations thereof;
wherein the non-aqueous composition is an adhesive.

12. A method of providing a bonded article comprising the steps of:
a. providing at least two substrates,
b. applying to at least one of the two substrates a non-aqueous composition comprising:
i. a styrene-containing polymer,
ii. modifying agent, and
iii. a solvent system comprising:
1. a volatile siloxane compound, and
2. a second compound selected from acetone, methyl acetate, tert-butyl acetate, para-chlorobenzotrifluoride, and combinations thereof;
wherein the non-aqueous composition is an adhesive, and
c. joining together the two substrates.
